(19) United States
(12) Patent Application Publication
(10) Pub. No.: US 2003/0051677 A1
(43) Pub. Date: Mar. 20, 2003

(54) Animal Hydrotherapy pool

(76) Inventors: Bradley Russell Smith, Diss (GB); Catherine Elizabeth Smith, Diss (GB)

Correspondence Address: William M. Lee, Jr., Lee, Mann, Smith, McWilliams, Sweeny & Ohlson, P.O. Box 2786, Chicago, IL, 60690-2786, US

(21) Appl. No.: 10/242,387

(22) Filed: Sep. 11, 2002

(30) Foreign Application Priority Data
Sep. 18, 2001 (GB) 0122491.4

(51) Int. Cl. A63B 31/00; A01K 29/00

(52) U.S. Cl. 119/702; 119/673; 482/55

(57) ABSTRACT

An animal hydrotherapy pool is described comprising a container for water having nozzle means in a wall of the container directing in use one or more jets of water into the water in the container. An extension to a wall of the container forms a housing in which is located pump means adapted to re-circulate water to and from the container via the nozzle means. Pump control means is also located in the housing thereby to be accessible in use to a person controlling an animal using the pool. A second pump draws water from near the surface of the water in the pool through a skimmer, and returns the water to the pool via a water treatment path. The latter comprises a heater, a sand filter, and an ozonator, and as described, all the water treatment devices are incorporated in the housing extension. In a preferred arrangement the return path from the second pump is divided into two parallel paths, both returning water to the pool, the ozonator is located in one of the two paths, which returns only a small fraction of the total volume of water which is returned to the pool by the second pump, and water not diverted through the path containing the ozonator is returned to the pool via the sand filter and heater. The flow rate through the ozonator path is adjustable, typically in the range 10-30% of the water drawn from the pool by the second pump, and for this purpose the path containing the ozonator includes an adjustable flow restrictor. The volume water flow through the nozzles is adjustable and a control panel is provided with controls enabling regulation of the water flow to the nozzles, control of the heater, and control of the percentage of water returned to the pool via the ozonator. The control panel also includes a control by which the second pump can be operated to backwash empty the pool.

### FIELD OF INVENTION

This invention relates to an animal hydrotherapy pool.

### BACKGROUND TO THE INVENTION

Hydrotherapy pools are especially but not exclusively used for exercising dogs, for example to aid loss of weight, but more generally to promote health and fitness after surgery.

GB Patent Specification 2,349,333 describes an animal hydrotherapy pool comprising a container for water having nozzle means in a wall of the container directing in use one or more jets of water into the water in the container, further comprises an extension to a wall of the container which forms a housing in which is located pump means adapted to re-circulate water to and from the container via the nozzle means, and pump control means thereby to be accessible in use to a person controlling an animal using the pool.

The container is rectangular and is adapted to stand at least partially above ground at floor level, and includes ramp means whereby an animal can be walked up the outside of the container into the pool and down into the water inside the container.

Typically an animal handler in charge of an animal using the pool will wish to control the animal by means of a collar attached to a pole or the like, and locating the pool above floor level assists the handler in this regard. The provision of the ramp means facilitates the entry and exit of an animal to and from the pool.

The jet nozzles are normally swivelable and are mounted at one end of the container, whilst the ramp means is located at the opposite end of the container. Locating the ramp means at the opposite end to the nozzles helps to reduce water spillage.

Provision is made for heating the water, and a replaceable filter cartridge water filtering system is also provided.

Both are located within the housing extension.

In use an animal is encouraged to swim against the force of the jets of water from the nozzles., The ability to swivel the nozzles enables the water issuing from the jets to be concentrated or dispersed, whereby to adjust the force of water against which the animal has to swim.

It is an object of the present invention to improve water quality in a hydrotherapy pool as described in GB 2,349,333.

### SUMMARY OF THE INVENTION

According to the present invention, a second pump is provided to draw water from near the surface of the water in the pool through a skimmer, and return the water to the pool via a return path which includes water treatment means.

Typically the water treatment means comprises a heater, a sand filter, and an ozonator.

The skimmer preferably includes a hair trap.

Conveniently, all the aforesaid water treatment devices are incorporated in the housing extension of the container.

In one arrangement all the returning water passes through the heater, filter and ozonator which are connected in series.

In a preferred system the return path is divided into two parallel paths, both returning water to the pool, and the ozonator is located in one of the two paths. Typically the latter returns a small fraction of the total volume of water which is returned to the pool. Although the ozonator therefore only treats a fraction of the water returning to the pool, if the second pump operates continuously during use of the pool, in time all the water win be treated by the ozonator as repeated recirculation takes place. Water not diverted through the path containing the ozonator is returned to the pool via the sand filter and the heater.

The flow rate through the ozonator path may be adjustable and typically is in the range of 10-30% of the water drawn from the pool by the second pump.

The addition of ozone to the water kills bacteria in the water and by diverting only a fraction of the water through the ozonator, so a smaller ozone unit can be employed. Furthermore the lower flow therethrough ensures that the water is fully exposed to the ozone which cannot be guaranteed if an ozonator has to handle a higher flow rate.

Since animals do not like being forced backwards in water, therefore the more concentrated the water force emanating from the jets, the harder the animal has to swim in order to remain substantially stationary and not be forced backwards by the flow. In addition to varying the force by swivelling the nozzles, it is preferable to adjust the power of the water jets by varying the volume flow of water through the nozzles (as opposed to the pressure), and thus alter the force against which the animal is to swim.

Typically the housing includes a control panel provided with controls enabling regulation of the water flow to the nozzles, control of the heater, and control of the percentage of water returned to the pool via the ozonator.

Preferably a control is also provided, typically on the control panel, by which the second pump can be operated to backwash empty the pool.

One example of an animal hydrotherapy pool embodying invention is now described with reference to the accompanying drawings, in which:

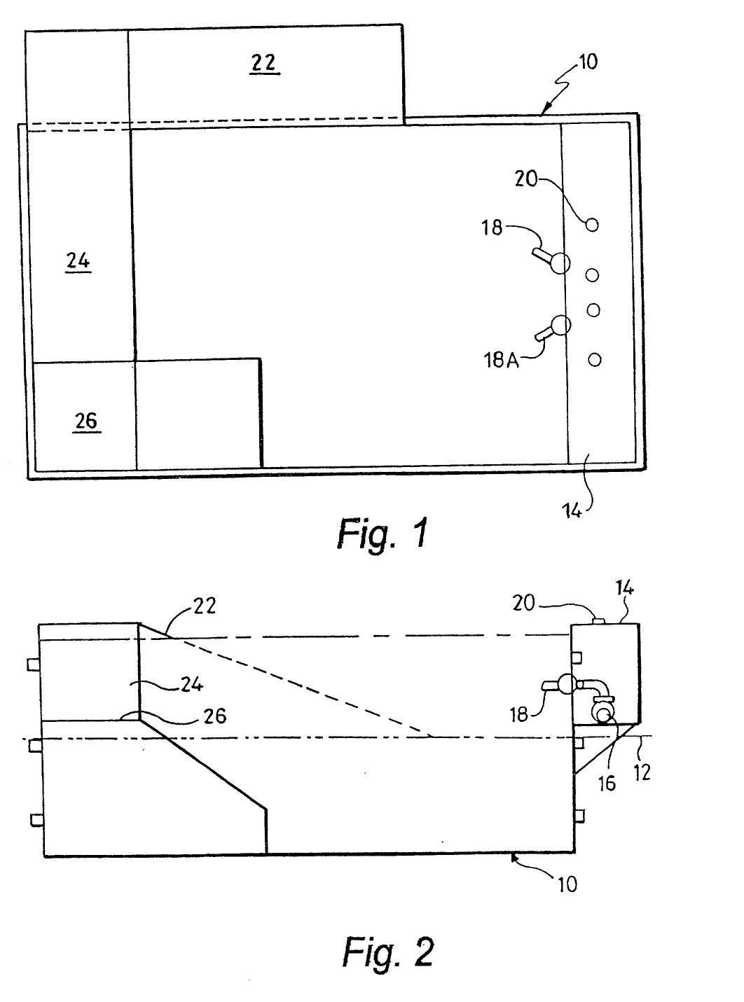

FIG. 1 is a plan view of the dog hydrotherapy pool described in GB 2,349,333;

FIG. 2 is a side view of the pool of FIG. 1;

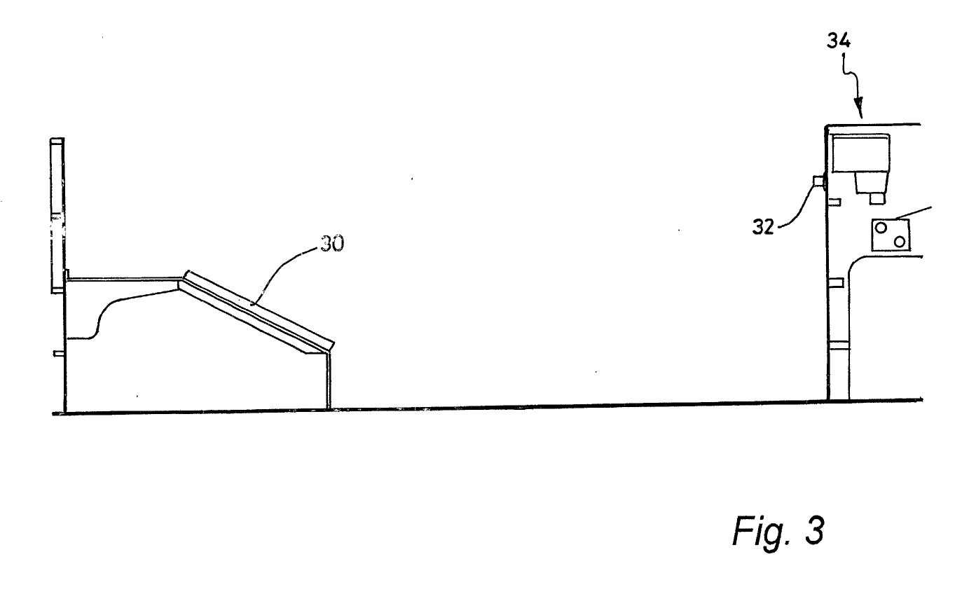

FIG. 3 is a side view of a similar pool having two pumps, sand filter, heater and ozonator and controls therefor in a housing extension, constructed in accordance with the invention; and

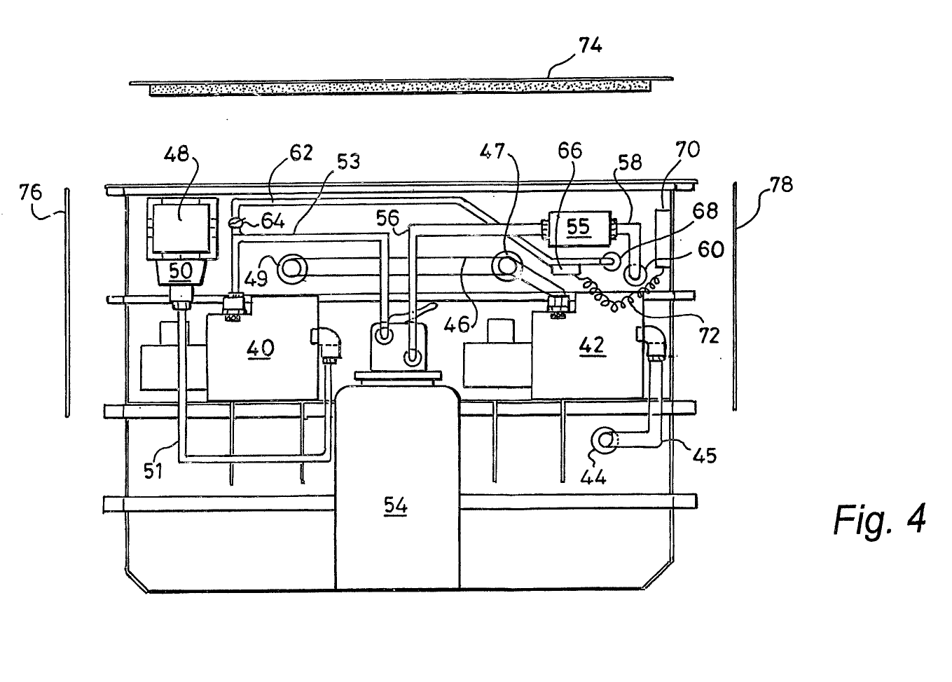

FIG. 4 is an end view of the housing extension of the pool of FIG. 3.

### DETAILED DESCRIPTION OF THE DRAWINGS

Referring to the FIGS. 1 and 2 of the drawings, a plastics (such as polypropylene) container 10 forming the base and walls of the pool is generally rectangular in shape. In practice, the container is sunk into the floor or ground to about half its height, which is typically just over 1 metre. Reference numeral 12 in FIG. 2 indicates the ground line in relation to the pool. The pool can be of any size, but typically is between 2 and 4 metres long and about 1½ metres wide.

At one end of the pool is an extension 14 constituting a housing for a pump 16. The pump 16 operates to re-circulate water extracted through outlets and pipework (not shown) back into the pool via two high pressure nozzles 18, 18A, which jet water back into the pool from the extension end towards the remote end.

The nozzles 18, 18A are mounted on ball joint or like connectors, so that they can be manually swivelled to concentrate or diverge the jets, and thus alter the force of the flow of water acting along the longitudinal centre line of the pool.

Due to this water flow, a dog, guided (as by means of a pole attached to its collar) to swim towards the end of the pool where the jets are located, tends to be forced backwards and, if the water flow is increased, has to swim harder simply in order to maintain its position. Since an animal tends to try and prevent itself being swept backwards, it will automatically exert more energy by swimming harder against the increased flow.

The dog can therefore be controllably exercised as appropriate to aid loss of weight or recovery from surgery, and more generally to promote health and fitness, by adjusting the angle of the nozzles and/or the rate of flow of water to the nozzles.

On/off controls and water pressure or flow rate controls 20 for the nozzles 18, 18A are conveniently placed on the extension 14 housing the water pump 16.

By virtue of sinking the pool in the ground or floor, leaving its top edge raised about 1/2 metre above ground or floor level, the dog handler is better able to control and guide a dog in the pool by means of a guide pole. On the other hand, when used by any dog other than a very small one, it can a problem to get the dog into and out of the pool.

In order to overcome this problem, ramps are provided at the end of the pool remote from the jets. As will be clear from FIGS. 1 and 2, these comprise an external ramp 22 from ground or floor level up the outside of the pool and an interior ramp 24 leading down into the pool to a horizontal platform 26 from which the dog can commence swimming. Conveniently, the dog handler can lead the dog into the pool with the guide pole already attached to its collar, preferably by means of a pivoting connector or a short lead. Once in the pool, the handler can guide the dog into the centre of the pool and encourage it to swim towards the jets, altering the angle of the nozzles and/or the flow rate from the jets, so as to counteract the swimming effort of the dog.

In accordance with the invention the water may be heated and cleaned and to this end a second pump is provided to extract water for heating and treatment, and re-circulation to the pool. Although not shown in FIGS. 1 and 2, it is convenient to house both the heater and a filter and an ozonator in the housing extension 14, with operational controls also provided on this extension. Incorporating all the ancillary equipment and controls therefor in the body of the pool unit is obviously advantageous for reducing installation costs, servicing is also simplified, especially if a replaceable cartridge filter is employed, and proximity to the pool assists an animal handler should they wish to adjust controls before or during a hydrotherapy session.

It will be clear that the pool can readily be adapted for use by animals other than dogs.

FIG. 3 shows a preferred embodiment of hydrotherapy pool in side view. The ramp is located at one end of the pool and is designated 30, and the jets at the other end (the front end), one nozzle of one of which is denoted by reference 32. At the front end can also be seen part of an extension housing 34 integrated with the container wall, but generally watertight with respect to the pool, in which is located the pumps and water treatment equipment for conditioning the water in the pool and control devices therefor.

FIG. 4 shows the water treatment equipment incorporated in the extension housing.

Referring specifically to FIG. 4, the water treatment equipment requires two pumps 40, 42. The pump 42 draws water directly from the pool via outlet 44 and pipe 45 and pressurises this water for return to the pool via pipe 46 and jets 47 and 49 having swivelable nozzles such as 32. The second pump 40 also draws water from the pool, but in this case through a skimmer 48 and hair trap 50 via pipe 51. The main return path (pipe 53) from the pump 40 to the pool, is via sand filter 54 and heater 55, the pipe between the filter 54 and heater 55 being denoted by 56. From the heater the water is returned to the pool along pipe 58 to water inlet 60. A parallel return path is provided by pipe 62 which includes an adjustable flow restrictor 64 and an ozone injector 66, and leads to a second inlet 68. An ozonator 70 is connected to the injector via connection 72.

Both pumps operate continuously during use of the pool, so that the water circulated by pump 40 quickly becomes substantially bacteria-free due to the action of the ozonator. Pump 40 also provides for backwashing and emptying of the pool. Pump 42, in particular, is adjustable to vary the jet pressure. Access to the treatment equipment for maintenance is provided by removing an insulated top panel 74 and/or side panels 76, 78. Controls for the pumps and the beater (not shown) may be positioned at any convenient point on the container wall or extension housing, as appropriate.

1. An animal hydrotherapy pool comprising a container for water having nozzle means in a wall of the container directing in use one or more jets of water into the water in the container, an extension to a wall of the container which forms a housing in which is located pump means adapted to re-circulate water to and from the container via the nozzle means, and pump control means thereby to be accessible in use to a person controlling an animal using the pool, further comprising a second pump adapted in use to draw water from near the surface of the water in the pool through a skimmer, and return the water to the pool via a return path which includes water treatment means.

2. An animal hydrotherapy pool as claimed in claim 1 wherein the water treatment means comprises a heater, a sand filter, and an ozonator.

3. An animal hydrotherapy pool as claimed in claim 1 or 2 wherein the skimmer includes a hair trap.

4. An animal hydrotherapy pool as claimed in claim 1, 2 or 3 wherein all the water treatment devices are incorporated in the housing extension of the container.

5. An animal hydrotherapy pool as claimed in nay preceding claim wherein all the returning water from the second pump passes through the heater, filter and ozonator which are connected in series.

6. An animal hydrotherapy pool as claimed in any of claim 1 to 4 wherein the return path from the second pump is divided into two parallel paths, both returning water to the pool, and the ozonator is located in one of the two paths.

7. An animal hydrotherapy pool as claimed in claim 6 wherein the path containing the ozonator returns a small fraction of the total volume of water which is returned to the pool by the second pump and water not diverted through the path containing the ozonator is returned to the pool via the sand filter and heater.

8. An animal hydrotherapy pool as claimed in claim 7 wherein the flow rate through the ozonator path is adjustable.

9. An animal hydrotherapy pool as claimed in claim 6 or 7 wherein the quantity of water diverted through the ozonator is in the range 10-30% of the water drawn from the pool by the second pump.

10. An animal hydrotherapy pool as claimed in any of claims 7 to 9 wherein the path containing the ozonator also includes an adjustable flow restrictor for controlling the flow of water therethrough.

11. An anal hydrotherapy pool as claimed in any of claims 1 to 10 wherein the volume flow of water through the nozzles is adjustable to alter the force against which an animal has to swim, in use.

12. An animal hydrotherapy pool as claimed in nay of claims 1 to 11 which includes a control panel provided with controls enabling regulation of the water flow to the nozzles, control of the heater, and control of the percentage of water returned to the pool via the ozonator.

13. An anal hydrotherapy pool as claimed in claim 12 wherein the control panel also includes a control by which the second pump can be operated to backwash empty the pool.

14. An animal hydrotherapy pool constructed arranged and adapted to operate substantially as herein described with reference to and as illustrated in FIGS. 3 and 4 of the accompanying drawings.
